(19) United States
(12) Patent Application Publication
(10) Pub. No.: US 2009/0172763 A1
(43) Pub. Date: Jul. 2, 2009

(54) METHOD, SYSTEM AND STREAM MEDIA SERVER FOR SUPPORTING MULTI AUDIO TRACKS

(75) Inventor: Weiyu LIU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/394,953

(22) Filed: Feb. 27, 2009

Related U.S. Application Data
(63) Continuation of application No. PCT/CN2007/001714, filed on May 28, 2007.

(30) Foreign Application Priority Data
Aug. 30, 2006 (CN) 200610111991.6

(51) Int. Cl. H04N 7/173

(52) U.S. Cl. 725/114

(57) ABSTRACT

A method for supporting multi audio tracks in wireless communication field, which uses multi stream media servers to share the assignment for supporting multi audio tracks. One stream media server receives one video data and multi audio data, but outputs only one determinate audio data; or one stream media server receives one video data and one audio data from multi audio data. User can select the required language by using portal website, and then connect to the stream media server for obtaining one video data and one audio data. The invention also provides a stream media server and a system for supporting multi audio tracks.

### CROSS-REFERENCE TO RELATED APPLICATIONS

This application is a continuation of International Patent Application No. PCT/CN2007/001714, filed May 28, 2007, which claims priority to Chinese Patent Application No. 200610111991.6, filed Aug. 30, 2006, both of which are hereby incorporated by reference in their entirety.

### FIELD OF THE INVENTION

The present invention relates to the field of communications, and in particular to a method, a system and a stream media server designed to support multiple audio tracks contents in the field of wireless multimedia.

### BACKGROUND OF THE INVENTION

With the development of technologies, mobile station devices have evolved to include some functions of computers, such as wireless network access and online receiving of stream media contents including TV programs, movies, etc. However, at present, an analog signal data stream only contains one channel of audio data and one channel of video data, that is, one channel of audio data only corresponds to a single audio track (one kind of language). If different users want to receive audio contents in different languages, multiple live broadcast encoders must be adopted to receive respective channels of audio information and video information; thus, two languages need at least two live broadcast encoders. The corresponding Session Description Protocol (SDP) file only contains the definition for one channel of audio data and one channel of video data, an instance of which is shown as follows:

```
v=0
o=− 2631350701 1507213 IN IP4 192.168.18.101
s=b3 14
c=IN IP4 236.130.128.182/1
b=RR:0
t=0 0
m=video 8686 RTP/AVP 96
b=AS:1920
a=rtpmap:96 H264/90000
a=fmtp:96
profile-level-id=4D4015;
sprop-parameter-sets=
        Z01AFZZWCwJNgyRAAAD6AAAYahgwADgnADqargAK,
        aO88gA==; packetization-mode=1
a=cliprect:0,0,576,352
a=framerate:25.
a=mpeg4-esid:21
a=x-envivio-verid:0002229A
m=audio 8688 RTP/AVP 97
b=AS:32
a=rtpmap:97 mpeg4-generic/16000/2
```

| | |
|---|---|
| a=fmtp:97 | profile-level-id=15; conFIG=1410; streamtype=5; |
| | ObjectType=64; mode=AAC-hbr; SizeLength=13; |
| | IndexLength=3; IndexDeltaLength=3 |

a=mpeg4-esid:101
a=lang:eng
a=x-envivio-verid:0002229^{a}

With the development of mobile terminal technologies and the increase of user demands, the above technical solution has not been adapted to the current demands. The users expect to watch a variety of TV programs in different languages. A conventional solution is to replicate one channel of video into multiple channels of video by means of a video replicator, match the multiple channels of video with multiple channels of audio, and then send the matched multiple channels of audio and video to multiple live broadcast encoders for encoding. With reference to FIG. 1, each solid arrow line denotes one channel of video, and each dotted arrow line denotes one channel of audio data. The three dotted arrow lines denote three channels of audio, i.e., three different languages. The video replicator needs to replicate the one channel of video to obtain another two channels of video, match the three channels of video with the three channels of audio respectively, and send each of the three channels of audio, together with one channel of video matching with this channel of audio, to a corresponding live broadcast encoder. Three live broadcast encoders are needed for the three channels of audio, and each of the live broadcast encoders sends information via two ports (one video port and one audio port) to a stream media server, and the stream media server forwards the information to a terminal device through a wireless network. Thus, requirements for live broadcast encoders and video replicators are increased, however, the live broadcast encoders are at present very high in price, and therefore the running cost will be increased significantly, and additionally subsequent maintenances will cause great inconveniences.

### SUMMARY OF THE INVENTION

An embodiment of the present invention provides a method, a system, and a stream media server for supporting multiple audio tracks, in order to solve the problems in the prior art, such as the problem of insufficient support for multiple audio tracks, higher cost, and maintenance difficulties.

A method of supporting multiple audio tracks is provided, which includes (1) sending one channel of video data and multiple channels of audio data having being processed to multiple stream media servers by a live broadcast encoder, wherein, the number of the stream media servers is not less than the number of channels of audio data; and (2) replicating the one channel of video data and one channel of the multiple channels of audio data and sending the replicated video data and audio data to a user's terminal by the stream media servers at the user's request, wherein, each of the stream media servers outputs one channel of the multiple channels of audio data.

A stream media server is provided, which includes (1) a receiving unit, adapted to receive one channel of video data and multiple channels of audio data from a live broadcast encoder; (2) a replicating unit, adapted to replicate the one channel of video data and one channel of the multiple channels of audio data; and (3) a sending unit, adapted to send the one channel of video data and the one channel of audio data replicated by the replicating unit to a terminal.

A stream media server is provided, which includes (1) a receiving unit, adapted to receive one channel of video data and one channel of multiple channels of audio data output from a live broadcast encoder; (2) a replicating unit, adapted to replicate the one channel of video data and the one channel of audio data received by the receiving unit; and (3) a sending unit, adapted to send one channel of video data and one channel of audio data replicated by the replicating unit to the terminal.

A system for supporting multiple audio tracks, which includes a live broadcast encoder and multiple stream media servers connected to the live broadcast encoder. The live broadcast encoder is adapted to perform an A/D conversion on one channel of analog video signal and multiple channels of analog audio signals received, and send the one channel of video data and multiple channels of audio data having being processed to the multiple stream media servers, wherein, the number of the stream media servers is not less than the number of the channels of video data. Each of the stream media server is adapted to replicate the one channel of video data and one channel of the multiple channels of audio data and send them to a user's terminal at the user's request, wherein, each of the stream media servers outputs one channel of audio data of the multiple channels of audio data.

According to an embodiment of the present invention, multiple stream media servers are used to support multiple audio tracks in a shared manner, in which each stream media server receives one channel of video signals and multiple channels of audio signals but outputs one channel of multiple channels of audio signals; or each stream media server receives one channel of video signals and one channel of multiple channels of audio signals. The stream media servers work together to support output of multiple channels of audio signals, so there is no need for video replicators or too much live broadcast encoders. The users' requirement for multiple languages can be met with reduced cost and network resources and easier maintenance. In addition, the technical solution of the present invention is applicable for a variety of wireless network systems.

### BRIEF DESCRIPTION OF THE DRAWINGS

FIG. 1 is a structural diagram of a network of supporting multiple audio tracks according to the conventional art;

FIG. 2A is a structural diagram of a network in which a user receives stream media contents according to an embodiment of the present invention;

FIG. 2B is a general flowchart of multiple servers supporting multiple audio tracks according to an embodiment of the present invention;

FIG. 3A is a structural diagram of a network in which a server receives multiple audio according to an embodiment of the present invention;

FIG. 3B is a structural diagram of a server which receives multiple audio according to an embodiment of the present invention;

FIG. 4 is a specific flowchart of a server receiving multiple audios according to an embodiment of the present invention; and

FIG. 5 is a specific flowchart of a server receiving a single audio according to an embodiment of the present invention.

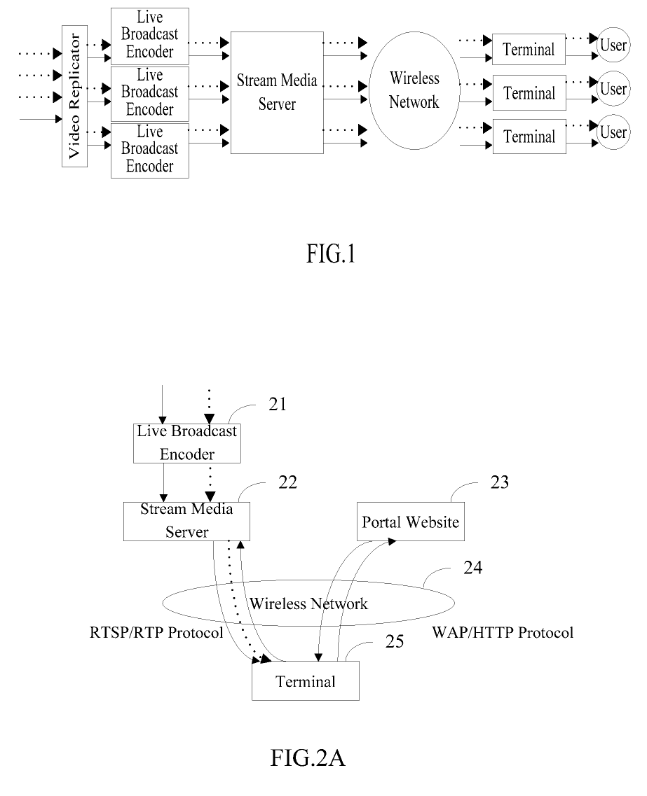

### DETAILED DESCRIPTION OF THE EMBODIMENTS

In an embodiment of the present invention, a live broadcast encoder and multiple stream media servers are used to support information broadcasts of multiple audio tracks; each of the stream media servers can output one channel of audio signal while outputting one channel of video signal. A user can log onto a portal website to choose a required language and obtain a link to a corresponding stream media server.

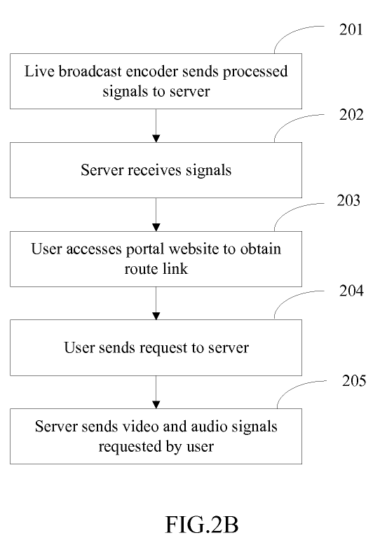

With reference to FIG. 2A, according to an embodiment, a basic network structure, by means of which a user receives stream media contents, includes a live broadcast encoder 21, a stream media server 22, a Wireless Application Protocol (WAP)/WEB portal website 23, a wireless network 24, and a terminal 25.

The live broadcast encoder 21 is adapted to receive analog TV signals of video and audio; convert the analog TV signals into digital signals and compress the digital signals; and then send the compressed signals to the stream media server 22.

The stream media server 22 is adapted to receive the compressed signals from the live broadcast encoder 21, and replicate and send required signals to a user according to the request of the terminal 25.

The WAP/WEB portal website 23 is adapted to provide the user with a network service interface and provide links to relevant services.

The wireless network 24 is adapted to provide a platform for interaction between the terminal 25 and the stream media server 22, and interaction between the terminal 25 and the WAP/WEB portal website 23 in the network.

The terminal 25 is adapted to connect to the stream media server 22 based on RTSP/RTP protocols via the wireless network 24, and connect to the WAP/WEB portal website 23 based on WAP/HTTP protocols via the wireless network 24; the user can watch stream media contents using the terminal. The terminal 25 may be a mobile telephone, a personal digital assistant (PDA), or any device that can access the network in wireless manner.

The user logs onto the WAP/WEB portal website 23 via the wireless network 24 using the terminal 25, chooses a desired program and language, obtains a corresponding route link, URL (Uniform Resource Locator), and establishes a connection to the stream media server 22 by means of the route link. After receiving the URL requested from the terminal 25, the stream media server 22 parses a corresponding SDP file to obtain a data transmission port of the live broadcast encoder 21. By listening in the corresponding port, the stream media server 22 obtains audio signals and video signals sent from the live broadcast encoder 21, replicates the audio signals and video signals, and then sends the replicated audio signals and video signals to the terminal 25 via the wireless network 24. The terminal 25 then decodes and displays the received audio signals and video signals.

The link information provided by the WAP/WEB portal website 23 is shown as follows:

| | |
|---|---|
| Sex and the City (English) | RTSP://IP1/TV.SDP |
| Sex and the City (Chinese) | RTSP://IP2/TV.SDP |
| Sex and the City (Cantonese) | RTSP://IP3/TV.SDP |

The user chooses a language therefrom and obtains a link to a corresponding audio track.

The corresponding relationship between language and audio track needs to be specified in advance in either of the following two ways.

1. The sequence of the audio tracks in different languages needs to be specified through the interface when the live broadcast encoder encodes the audio data, for example, the first audio track is in English, the second audio track is in Chinese, and the third audio track is in Cantonese, etc. The operational manuals of the corresponding live broadcast encoder may be referred to for details.

2. The encoder adds a tag to each audio track when encoding the audio data. In this way, different languages can be identified with different tags, for example, the name of the tag may be Chinese, English, French, and German—the name of a tag may not necessarily represent the corresponding language, but can be used to represent any other language as required. For example, if Japanese is required, the tag name “German” may be used to represent Japanese.

With reference to FIG. 2B, in this embodiment, the main flow of supporting multiple audio tracks by multiple stream media servers is as follows.

Step 201: After converting received analog signals, which include one channel of analog video signals and multiple channels of analog audio signals, into digital signals and compressing the digital signals, the live broadcast encoder 21 sends the compressed signals to the multiple stream media servers 22. The number of the stream media servers 22 is not less than the number of the channels of audio signals.

Step 202: The multiple stream media servers 22 receive the one channel of video signals, and, the multiple channels of audio signals or one channel of the multiple channels of audio signals.

Step 203: A user accesses the WAP/WEB portal website 23 with the terminal 25, chooses a language, and obtains a route link to a stream media server 22.

Step 204: The user sends a request to the stream media server 22.

Step 205: The stream media server 22 locally replicates the one channel of video signals and a specified channel of audio signals and sends the replicated video and audio signals to the terminal 25 according to the user's request.

According to this embodiment, each stream media server receives one channel of video signals and multiple channels of audio signals, and the multiple stream media servers support multiple audio tracks. In configuration files, an audio track is specified by an audio track number or an audio track tag, indicating the audio track corresponding to the audio signals that can be output by a server along with one channel of video signals; or, each stream media server receives one channel of video signals and one channel of the multiple channels of audio signals, and the multiple stream media servers support output of all audio signals, the number of the stream media servers is not less than the number of the channels of audio signals. In case of traffic congestion in the network, the multiple stream media servers can output the same channel of audio signals when they output the same channel of video signals.

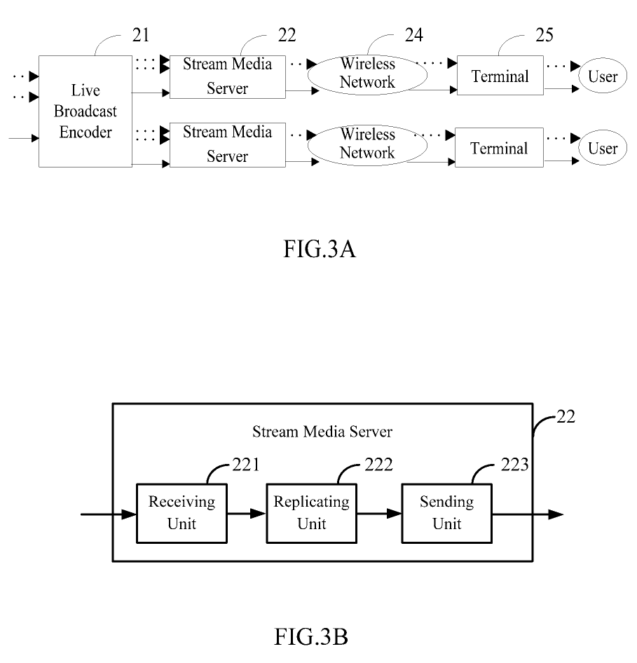

With reference to FIG. 3A, according to an embodiment, a network of supporting multiple audio tracks includes a live broadcast encoder 21, two stream media servers 22, two wireless networks 24, and two terminals 25. The network further includes a WAP/WEB portal website 23 (not shown). Although the embodiment is illustrated by the example of two stream media servers, the number of stream media servers may be set as required.

The live broadcast encoder 21 is adapted to receive analog TV signals including one channel of video signals and two channels of audio signals, convert them into digital signals and compress the digital signals, generate an SDP file, and then send the compressed digital signals including one channel of video signals and two channels of audio signals to the two stream media servers 22, respectively.

The two stream media servers 22 are adapted to receive the digital signals including one channel of video signals and two channels of audio signals sent from the live broadcast encoder 21. The contents received by the two stream media servers are identical. The stream media servers 22 each replicate one channel of audio signals and one specified channel of audio signals according to parameter settings in a local configuration file, and then send the replicated signals to the wireless network 24. The configuration file in the stream media servers 22 specifies different audio signals on different audio tracks. Another approach is: each of the two stream media servers receives one channel of video signals and one channel of the two channels of audio signals sent from the live broadcast encoder 21, i.e., the two stream media servers receive different channels of audio signals corresponding to the same channel of video signals. In that case, no parameter information of audio tracks is added in the local configuration file.

The multiple stream media servers may have the same configuration file, i.e., they can output the same audio signals when they output the same video signals, and the wireless network 24 indicates to which stream media server the terminal 25 is connected.

The two wireless networks 24 are adapted to provide a platform for interaction between the stream media server 22 and the terminal 25, and interaction between the terminal 25 and the WAP/WEB portal website 23.

The two terminals 25 are adapted to connect to the WAP/WEB portal website 23 through the wireless network 24 and receive stream media signals forwarded via the wireless network 24. Users may watch the stream media contents with the terminals and release contents that have been played. If the multiple terminals 25 request the same channel of audio signals corresponding to the same channel of video signals, the wireless network 24 may send the stream media data stream to the terminals 25 in multicast mode. If one terminal 25 makes a request, the wireless network 24 may send in unicast mode.

The wireless networks 24 subsequently connected to the two stream media servers 22 are not required to be connected in a fixed way, but they may be cross-connected, or they may be the same wireless network. Likewise, either of the two terminals 25 may be subsequently connected to the wireless network 24, depending on actual situations.

With reference to FIG. 3B, the stream media server 22 includes a receiving unit 221, a replicating unit 222, and a sending unit 223. The receiving unit 221 receives the stream media data stream containing one channel of video signals and multiple channels of audio signals output from the live broadcast encoder. The replicating unit 222, according to the request of the terminal 25, reads the local configuration file which specifies one channel of the multiple channels of audio signals, and replicates the one channel of video signals and the specified channel of audio signals. The sending unit 223 sends the one channel of video signals and the channel of audio signals replicated by the replicating unit 222 to the terminal 25.

According to another embodiment, as shown in FIG. 3B, the stream media server 22 includes a receiving unit 221, a replicating unit 222, and a sending unit 223; in which the receiving unit 221 receives the stream media data stream containing one channel of video signals and one channel of the multiple channels of audio signals output from the live broadcast encoder, according to parameter information and port numbers in the local SDP file. The replicating unit 222 replicates the one channel of video signals and the one channel of audio signals according to the request of the terminal 25. The sending unit 223 sends the one channel of video signals and the one channel of audio signals replicated by the replicating unit 222 to the terminal 25.

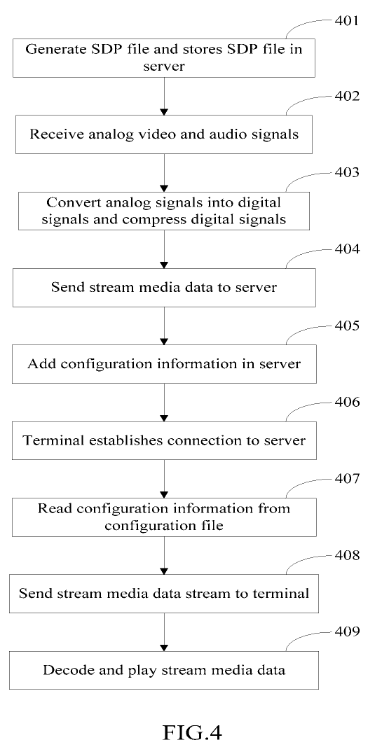

With reference to FIG. 4, according to an embodiment, multiple audio tracks are supported by multiple stream media servers, each of which receives the same one channel of video signals and multiple channels of audio signals. The procedure of receiving the same one channel of video signals and multiple channels of audio signals is as follows.

Step 401: The live broadcast encoder 21 generates an SDP file, and sends the SDP file to the two stream media servers 22. The live broadcast encoder 21 defines that the first audio track is in English and the second audio track is in Chinese, in which the audio track can be identified by a number or tag. The SDP file contains parameter information of two channels of audio and one channel of video, wherein, each channel of the signals is specified to be sent via a specific port. An example of the SDP file is shown as follows.

```
v=0
o=− 2631350701 1507213 IN IP2 192.168.18.101  //The name of the user at the
        session initiating end is “-”, the session ID is 2631350701, the session
        version is 1507213, the network type is Internet, the address type is ipv4,
        and the address is 192.168.18.101
s=b3 14
c=IN IP2 236.130.128.182/1  //Description of connection data: the network type is
        Internet, the address type is ipv4, and the address is 236.130.128.182
b=RR:0
t=0 0
m=video 8686 RTP/AVP 96  //Start the description of the video media information;
        the video media data will be sent to port 8686, based on UDP-based RTP
        protocol, in format “96”(dynamic RTP load type)
b=AS:1920  //Description of bandwidth, bandwidth=15kbps
a=rtpmap:96 H264/90000  //Description of load type “96”:  in the format of H264
        code, at a sampling clock rate of 90000Hz
a=fmtp:96  profile-level-id=4D4015;
        sprop-parameter-sets=Z01AFZZWCwJNgyRAAAD6AAAYahgwADgnA
        DqargAK,
aO88gA==; packetization-mode=1  //Further provide parameters of load type “96”
a=cliprect:0,0,576,352
a=framerate:25.  //Frame rate:  15fps
a=mpeg4-esid:21  //Correspond to stream ID 201 (the video file may contain
        multiple video streams and audio streams, each of which is allocated an ID.
        In this example, the ID of the video stream is 201)
a=x-envivio-verid:0002229A
m=audio 8688 RTP/AVP 97  //Start the description of the first channel audio media
        information.  The audio media data will be sent to port 8688, in
        UDP-based RTP protocol, in format “97” (dynamic RTP load type)
b=AS:32
a=rtpmap:97 mpeg4-generic/16000/2
a=fmtp:97  profile-level-id=15;  conFIG=1410;  streamtype=5;  ObjectType=64;
        mode=AAC-hbr; SizeLength=13; IndexLength=3; IndexDeltaLength=3
a=mpeg4-esid:101
a=lang:eng  //ID of each audio track; used to differentiate different audio tracks, but
        not necessarily represent it must be this language
a=x-envivio-verid:0002229A
m=audio 8690 RTP/AVP 14  //Start the description of the second channel audio
        media information
b=AS:48
a=rtpmap:14 MPA/48000/2
a=mpeg4-esid:102
a=lang:chi
a=x-envivio-verid:0002229A
```

Step 402: The live broadcast encoder 21 receives one channel of analog video signals and two channels of analog audio signals.

Step 403: At the live broadcast encoder 21, the analog signals are converted into digital signals through A/D conversion, and the digital signals are compressed.

Step 404: The two stream media servers 22 receive the stream media data stream (one channel of video signals and two channels of audio signals) sent from the live broadcast encoder 21 in real time by listening to the port specified in the received SDP file.

Step 405: The two stream media servers 22 receive the stream media data stream, and add relevant information in a local configuration file to specify one channel of audio. The configuration files in the two stream media servers 22 are different from each other, and different audio channels are specified corresponding to the same one video. For example, take the stream media server 22 as an example, if the second audio track is specified in the configuration file, the corresponding language is Chinese. Examples of such a configuration file are shown as follows.

Audio_channel_id=2(1,2,3)
or
Audio_language= Chinese (English, Chinese, Cantonese)

Step 406: The terminal 25 accesses the WAP/WEB portal website 23 through the wireless network 24 and chooses a language; for example, select “Chinese.” Accordingly, read the route address “RTSP://IP2/TV.SDP” of the audio track, which corresponds to the audio track “Sex and the City” defined by the live broadcast encoder 21; then the corresponding stream media server 22 can be located through IP2, and the specific channels of video and audio signals in the stream media server 22 can be located according to the TV.SDP file. The terminal 25 establishes a connection to the stream media server 22, in which the language of audio corresponding to the specific video is Chinese, and sends a request to the stream media server 22.

Step 407: When receiving the request from the terminal 25, the connected stream media server 22 reads the configuration file, which specifies that the stream media server 22 can send audio signals in Chinese or support the second audio track corresponding to one channel of video signals selected by the user.

Step 408: The connected stream media server 22 locally searches for one channel of video signals and one channel of audio signals in Chinese that can be output corresponding to the channel of video, replicates them, and sends the one channel of video signals and one channel of audio signals to the terminal 25 through the wireless network 24.

Step 409: The terminal 25 decodes the one channel of video signals and the one channel of audio signals in Chinese after it receives them and plays them to the user.

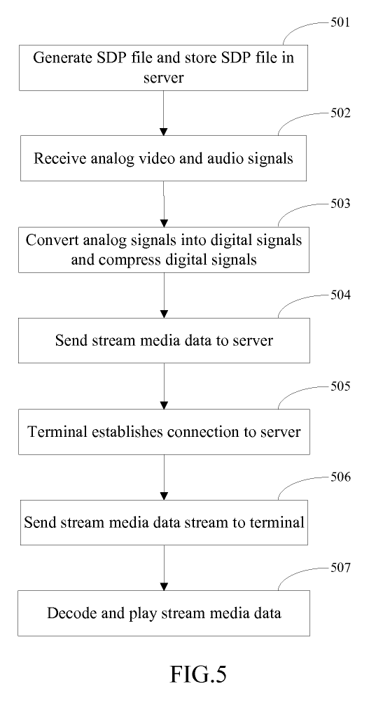

With reference to FIG. 5, according to an embodiment, multiple audio tracks are supported by multiple stream media servers, each of which receives one channel of video signals and one channel of the multiple channels of audio signals. The procedure is as follows:

Step 501: The live broadcast encoder 21 generates an SDP file containing parameter information of one channel of video signals and multiple channels of audio signals, and corresponding port numbers, and defines that the first audio track is in English and the second audio track is in Chinese, which may be identified by a number or tag. Then, the SDP file containing all the information is split manually or automatically into two SDP files each containing one channel of audio signals, and the two SDP files are sent to the two stream media servers 22 respectively. The two SDP files specify the parameter information of the same channel video signals and different channels of audio signals and corresponding port numbers. The SDP file in a stream media server 22 contains the parameter information of one channel of video signals and one channel of the two channels of audio signals, wherein, the one channel of video signals and the one channel of audio signals are specified to be sent via a specific port. Take one of the stream media servers 22 as an example, the stream media server 22 supports a first audio track, and the corresponding language is “English.” An example of the SDP file is shown as follows.

```
v=0
o=− 2631350701 1507213 IN IP4 192.168.18.101
s=b3 14
c=IN IP4 236.130.128.182/1
b=RR:0
t=0 0
m=video 8686 RTP/AVP 96
b=AS:1920
a=rtpmap:96 H264/90000
a=fmtp:96  profile-level-id=4D4015;
          sprop-parameter-sets=
          Z01AFZZWCwJNgyRAAAD6AAAYahgwADgnA DqargAK,
aO88gA==; packetization-mode=1
a=cliprect:0,0,576,352
a=framerate:25.
a=mpeg4-esid:21
a=x-envivio-verid:0002229A
m=audio 8688 RTP/AVP 97
b=AS:32
a=rtpmap:97 mpeg4-generic/16000/2
a=fmtp:97  profile-level-id=15;  conFIG=1410;  streamtype=5;
          ObjectType=64; mode=AAC-hbr; SizeLength=13;
          IndexLength=3; IndexDeltaLength=3
a=mpeg4-esid:101
a=lang:eng
a=x-envivio-verid:0002229A
```

Wherein, the port of the audio track is m=audio 8688 RTP/AVP 97, and the corresponding audio channel is a=lang:eng.

The SDP file in the other stream media server 22 contains the parameter information for one channel of video signals and one channel of audio signals, wherein, this channel of video signals and this channel of audio signals are specified to be sent via a specific port. The stream media server 22 supports a second audio track, and the corresponding language is “Chinese.” An example of the SDP file is shown as follows.

```
v=0
o=− 2631350701 1507213 IN IP4 192.168.18.101
s=b3 14
c=IN IP4 236.130.128.182/1
b=RR:0
t=0 0
m=video 8686 RTP/AVP 96
b=AS:1920
a=rtpmap:96 H264/90000
a=fmtp:96  profile-level-id=4D4015;
          sprop-parameter-sets=
          Z01AFZZWCwJNgyRAAAD6AAAYahgwADgnA DqargAK,
aO88gA==; packetization-mode=1
a=cliprect:0,0,576,352
a=framerate:25.
a=mpeg4-esid:21
a=x-envivio-verid:0002229A
m=audio 8690 RTP/AVP 14
b=AS:48
a=rtpmap:14 MPA/48000/2
a=mpeg4-esid:102
a=lang:chi
a=x-envivio-verid:0002229A
```

Wherein, the port for the audio track is m=audio 8690 RTP/AVP 14, and the corresponding audio track is a=lang:chi.

Step 502: The live broadcast encoder 21 receives one channel of analog video signals and two channels of analog audio signals, wherein, the first audio channel is in English, and the second audio channel is in Chinese.

Step 503: At the live broadcast encoder 21 the analog signals are converted into digital signals, and the digital signals are compressed.

Step 504: The stream media server 22 receives the stream media data stream (one channel of video signals and one channel of audio signals in English among the multiple channels of audio signals) sent from the live broadcast encoder 21 in real time, by listening to the port specified in the received SDP file.

Step 505: The terminal 25 accesses the WAP/WEB portal website 23 through the wireless network 24. The user chooses a language with the terminal 25, for example, select “English,” and accordingly, the terminal reads the route address “RTSP://IP1/TV.SDP” of the audio track, which corresponds to the audio track “Sex and the City” in the live broadcast encoder 21, and establishes a connection to the stream media server 22 that is specified by the route address and receives this channel of audio signals in English corresponding to this channel of video signals.

Step 506: After receiving a request from the terminal 25, the connected stream media server 22 locally replicates the one channel of video signals and the one channel of audio signals in English, and sends the one channel of video signals and one channel of audio signals in English to the terminal 25 through the wireless network 24.

Step 507: When receiving the one channel of video signals and the one channel of audio signals in English, the terminal 25 decodes them and plays them to the user.

In the embodiments of the present invention, multiple stream media servers are used to support multiple audio tracks tasks in a shared way, wherein, one stream media server receives one channel of video signals and multiple channels of audio signals but outputs one channel of audio signals among the multiple channels of audio signals; or one stream media server receives one channel of video signals and one channel of the multiple channels of audio signals. The stream media servers work together to support output of the multiple channels of audio signals, and therefore can meet the users' demands for multiple languages and save network resources, without the need for video replicators or too much live broadcast encoders, thereby decreasing the cost and facilitating maintenance. In addition, the technical solution of the present invention can be applied to a variety of wireless networks, such as GPRS (General Packet Radio Service), EDGE (Enhanced Data Rate for GSM Evolution), WCDMA (Wideband Code Division Multiple-Access), CDMA 2000 (Code Division Multiple-Access 2000), TD-SCDMA (Time Division—Synchronous Code Division Multiple Access), DVB-H (Digital Video Broadcast-Handheld), DMB (Digital Multimedia Broadcasting), and ISDB-T (Integrated Service Digital Broadcasting-Terrestrial), etc. In a mobile network, the terminals can use the interaction technique in a point-to-point manner (unicast technique) or use the technique through DVB-H, DMB, MBMS (Multimedia Broadcast Multicast Service), or Broadcast and Multicast Services (BCMCS) manner in multicast manner.

Apparently, those skilled in the art could make various variations and modifications without departing from the spirit and the scope of the present invention. The present invention is intended to include all these variations and modifications if they fall within the scope of the appended claims and equivalents thereof.

1. A method for supporting multiple audio tracks comprising:
sending one channel of video data and multiple channels of audio data to a stream media server by a live broadcast encoder; and
replicating the one channel of video data and one channel of the multiple channels of audio data and sending the replicated video data and audio data to a user's terminal according to the user's request by the stream media server.

2. The method of claim 1, wherein, the live broadcast encoder sends an Session Description Protocol (SDP) file containing port numbers for the one channel of video data and the multiple channels of audio data to the stream media server, and the stream media server receives the one channel of video data and the multiple channels of audio data by listening to the ports.

3. The method of claim 2, wherein, the SDP file further contains parameter information for the one channel of video data and the multiple channels of audio data, and the stream media server specifies, in a local configuration file, the one channel of the multiple channels of audio data to be replicated according to the SDP file.

4. The method of claim 1, wherein, the live broadcast encoder sends an SDP file containing port numbers for the one channel of video data and the one channel of the multiple channels of audio data to the stream media server, and the stream media server receives the one channel of video data and the one channel of the multiple channels of audio data by listening to the ports.

5. The method of claim 1, wherein, the one channel of the multiple channels of audio data is specified by an audio track number or tag.

6. The method of claim 5, wherein, the audio track number or tag is specified in the configuration file in the stream media server.

7. The method of claim 5, wherein, a link to a stream media server is established in a portal website, and the link comprises the audio track number or tag.

8. A stream media server comprising:
a receiving unit, adapted to receive one channel of video data and multiple channels of audio data output from a live broadcast encoder;
a replicating unit, adapted to replicate the one channel of video data and one channel of the multiple channels of audio data specified by a local configuration file; and
a sending unit, adapted to send the one channel of video data and the one channel of audio data replicated by the replicating unit to a terminal.

9. A stream media server comprising:
a receiving unit, adapted to receive one channel of video data and one channel of multiple channels of audio data output from a live broadcast encoder;
a replicating unit, adapted to replicate the one channel of video data and the one channel of audio data received by the receiving unit; and
a sending unit, adapted to send the one channel of video data and the one channel of audio data replicated by the replicating unit to the terminal.

10. A system for supporting multiple audio tracks, comprising a live broadcast encoder and multiple stream media servers connected to the live broadcast encoder, wherein
the live broadcast encoder is adapted to send one channel of video data and multiple channels of audio data to the multiple stream media servers; and
the stream media server is adapted to replicate the one channel of video data and one channel of the multiple channels of audio data and send the replicated video data and audio data to a user's terminal according to the user's request.

11. The system of claim 10, further comprising:
a portal website, adapted to establish a link to the stream media server, wherein the link comprises of an audio track number or tag that specifies the one channel of the multiple channels of audio data.
